(19) United States
(12) Patent Application Publication
(10) Pub. No.: US 2025/0346440 A1
(43) Pub. Date: Nov. 13, 2025

(54) STORAGE TABLE OF A PACKAGING PLANT AND DEVICE FOR IN- OR OUT-FEEDING PACKAGES INTO OR OUT OF A STORAGE LINE OF A STORAGE TABLE

(71) Applicant: Illinois Tool Works Inc., Glenview, IL (US)

(72) Inventors: Hartmut Korte, Bramsche (DE); Sebastian Breeck, Neuenkirchen (DE)

(73) Assignee: Illinois Tool Works Inc., Glenview, IL (US)

(21) Appl. No.: 18/860,077

(22) PCT Filed: May 19, 2023
(86) PCT No.: PCT/US2023/067248

§ 371 Date: Oct. 25, 2024

(30) Foreign Application Priority Data
May 20, 2022 (EP) 22174576.3

(51) Int. Cl. B65G 47/51; B65G 21/20; B65G 47/71

(52) U.S. Cl. CPC B65G 47/5104; B65G 21/2054; B65G 47/71

(57) ABSTRACT

The invention relates to a storage table of a packaging plant, wherein the storage table includes an infeed, an outfeed, and at least two storage lines that are loadable separately from one another and are arranged between the infeed and the outfeed. The infeed includes a loading means having a conveyor channel, wherein the loading means having the conveyor channel is designed to receive packages from a conveyor apparatus arranged upstream of the storage table and to convey the packages onwards and, in particular, to deflect the packages so that the packages can be received in at least one of the two storage lines. The loading means is designed to be adaptable, in particular as needed, in such a way that a width and/or height of the conveyor channel is adjustable at least in certain areas or sections.

### CROSS-REFERENCE TO RELATED APPLICATIONS

This application is a national phase entry of, and claims priority to, International Patent Application No. PCT/US2023/067248 (filed 19 May 2023), which claims priority to European Patent Application No. 22174576.3 (filed 20 May 2022), the entire disclosures of which are incorporated herein by reference.

### TECHNICAL FIELD

The present invention relates generally to packaging lines of a packaging plant, and more particularly to storage tables of a packaging plant.

### BACKGROUND

Packaging plants are characterized by a large number of packaging stations (packaging apparatuses, which further process the packages in different working steps. For example, in bottling plants, a straw applicator and then a shrink film applicator are usually employed after a filling machine. In the shrink film applicator, several packages are combined into one bundle. These packaging stations mentioned are purely exemplary and other configurations are of course also conceivable.

In the context of the usual development of a packaging plant, the focus is always on the processing rate (i.e., the number of packages per time unit). The higher the packing rate is, the more efficient is the plant. Therefore, the goal is always to increase the processing rate of each individual apparatus and thus the entire packaging plant. When operating a packaging plant, the goal is to operate the slowest packaging apparatus at its maximum processing rate, so that the throughput of packages in a packaging plant is maximized to the extent possible.

On the other hand, it is unavoidable in the operation of a packaging plant that disruptions can also occur during the processing of the packages at individual packaging apparatuses. In order to be able to maintain a production process that is as disruption-free as possible and/or to compensate for fluctuations in the processing rate of packaging apparatuses of the packaging plant, it is common practice for a storage device, in particular in the form of a storage table, to be arranged between two packaging apparatuses.

The storage table receives packages if a disruption occurs downstream of the storage table in the packaging plant and the packages can no longer be processed further downstream. As soon as the downstream disruption has been remedied, the packages temporarily stored on the storage table can be retrieved from the storage table and processed further.

Accordingly, by using the storage table it is possible to continue to operate the packaging apparatuses or other apparatuses upstream with regard to the storage table for a certain period of time, at least until the storage table is filled, i.e., the capacity of the storage table is exhausted.

Accordingly, the use of a storage table satisfies the failure safety of an upstream apparatus in the event of a failure of a downstream apparatus, since the upstream apparatus can always first fill the storage table with packages before it too has to be switched off. If the disruption of the downstream apparatus is resolved beforehand, the upstream apparatus can continue to operate without interruption.

A storage table of the type considered herein is described, for example, in EP 3 854 732 A1.

The storage table known from this state of the art includes an infeed, an outfeed and a plurality of storage lines that are loadable separately from one another and are arranged between the infeed and the outfeed. The infeed and the outfeed of the storage table known from EP 3 854 732 A1 are each realized as a linearly operated satellite, which is movable perpendicularly to the storage lines.

Since a storage table is always a cost factor for a packaging plant, there is a need for a storage table that can be used as flexibly as possible.

### BRIEF SUMMARY

In particular, the invention is therefore based on the object of providing a storage table, which is basically suitable for temporarily storing different types of packages. The packages differ in particular in their size.

This object is achieved in particular by the subject matter of independent patent claim 1, wherein advantageous developments of the storage table according to the invention are indicated in the dependent claims.

Accordingly, the invention relates in particular to a storage table of a packaging plant, wherein the storage table includes at least one infeed, at least one outfeed, and at least two storage lines that are loadable separately from one another and are arranged between the at least one infeed and the at least one outfeed.

In order for the storage table can also be used as flexibly as possible for different package sizes and/or types of packages, in particular, also for packages having different degrees of complementation, it is provided according to the invention in particular that the at least one infeed includes a loading means having a conveyor channel, wherein the loading means having the conveyor channel is designed to receive packages from a conveyor apparatus arranged upstream of the storage table and to convey them onwards and, in particular, to deflect them so that the packages can be received in at least one of the two storage lines.

According to the invention, it is provided that the loading means is designed to be adaptable, in particular as needed, in such a way that a width and/or height of the conveyor channel is adjustable at least in certain areas or sections.

Since the loading means is realized to be adaptable, the storage table is able to receive different packages, packages with a different degree of complementation, or packages of different sizes and/or shapes. Overall, the storage table can therefore be used particularly flexibly and can be adapted in the event of a design change to the packages to be processed.

According to implementations of the storage table according to the invention, it is provided that the loading means of the at least one infeed is realized as a linearly operated satellite, which is movable transversely and preferably perpendicularly to the at least two storage lines.

In particular, it is conceivable in this context that the loading means of the at least one infeed is realized as a linearly operated deflector, which is movable transversely and preferably perpendicularly to the at least two storage lines und which is designed to deflect the packages along their conveying or transport direction, starting from the conveyor apparatus arranged upstream of the storage table, so that they are moved to a specific, predetermined or determinable storage line of the at least two storage lines.

Different solutions are possible for adapting the loading means.

According to a preferred implementation, it is provided that the conveyor channel of the at least one infeed includes two side areas arranged opposite one another and defining a conveying or transport direction, wherein at least one of the two side areas arranged opposite one another is segmentally designed and includes a plurality of guide sections adjacent to one another. At least one of the guide sections and preferably all guide sections are movable and/or adjustable perpendicularly to the conveying or transport direction predefined by the conveyor channel as needed for adjusting the width of the conveyor channel at least in certain areas or sections.

According to a development of the last-mentioned embodiment, it is provided that at least one drive is assigned to the guide sections, which is realized in particular as a manually operable or electro-motorically operable drive, and which is designed to move and/or adjust the at least one guide section assigned to the drive perpendicularly to the conveying or transport direction predefined by the conveyor channel as needed.

In this case, it is advisable for the drive to include a synchronization apparatus, which is in particular mechanically designed and which is designed to transfer a movement and/or adjustment of one of the plurality of guide sections caused by the drive to the other of the plurality of guide sections preferably in such a way that these are also moved and/or adjusted with the one guide section.

As an alternative or in addition to the aspects described above, it is provided according to one aspect of the invention that the at least one outfeed includes a removal means having a conveyor channel, wherein the removal means having the conveyor channel is designed to receive packages received in one of the at least two storage lines and to convey them onwards and, in particular, to deflect them so that the packages can be received by a conveyor apparatus arranged downstream of the storage table.

As with the infeed, it is conceivable during the outfeed that the removal means is designed to be adaptable, in particular as needed, in such a way that a width and/or height of the conveyor channel is adjustable at least in certain areas or sections.

Preferably, the removal means of the at least one outfeed is realized as a linearly operated satellite, which is movable transversely and preferably perpendicularly to the at least two storage lines.

However, as an alternative or in addition to this, it is also conceivable for the removal means of the at least one outfeed to be realized as a linearly operated deflector, which is movable transversely and preferably perpendicularly to the at least two storage lines und which is designed to deflect the packages along their conveying or transport direction, starting from one storage line of the at least two storages lines assigned to the storage line, so that they are moved to the conveyor apparatus arranged downstream of the storage table.

As is also the case with the conveyor channel of the at least one infeed, it is provided according to preferred implementations of the storage table according to the invention, that the conveyor channel of the at least one outfeed includes two side areas arranged opposite one another and defining a conveying or transport direction, wherein at least one of the two side areas arranged opposite one another is segmentally designed and includes a plurality of guide sections adjacent to one another.

At least one of the guide sections and preferably all guide sections are movable and/or adjustable perpendicularly to the conveying or transport direction predefined by the conveyor channel as needed for adjusting the width of the conveyor channel at least in certain areas or sections.

In principle, it is advisable that a conveyor apparatus having at least one preferably circulating conveyor belt or having at least one preferably circulating conveyor chain is assigned to the conveyor channel, wherein the conveyor belt or conveyor chain is aligned at least substantially vertically and extends over the plurality of guide sections adjacent to one another in a guided manner along at least one of the two side areas arranged opposite one another.

The invention further relates to a device for in-or out-feeding packages into a storage line or out of a storage line of a storage table, in particular, a storage table of the aforementioned type according to the invention.

The device preferably includes an in particular linearly operated satellite or deflector, which is movable transversely and preferably perpendicularly to the storage line of the storage table. The satellite or deflector includes a conveyor channel via which packages are conveyable to or from the storage line. In particular, it is provided in this context that the satellite or deflector is designed to be adaptable, in particular as needed, in such a way that a width and/or height of the conveyor channel (2) is adjustable at least in certain areas or sections.

In the device for in-or out-feeding packages into a storage line or out of a storage line according to the invention, it is preferably provided that the conveyor channel includes two side areas arranged opposite one another and defining a conveying or transport direction, wherein at least one of the two side areas arranged opposite one another is segmentally designed and includes a plurality of guide sections adjacent to one another. At least one of the guide sections and preferably all guide sections are movable and/or adjustable perpendicularly to the conveying or transport direction predefined by the conveyor channel as needed for adjusting the width of the conveyor channel at least in certain areas or sections.

In a preferred manner, it is provided in this context that a conveyor apparatus having at least one preferably circulating conveyor belt or having at least one preferably circulating conveyor chain is assigned to the conveyor channel. The conveyor belt or conveyor chain is aligned at least substantially vertically and is guided over the plurality of guide sections along at the least one of the two side areas arranged opposite one another.

In this context, it is advisable that an in particular spring-loaded tensioning element is assigned to the conveyor belt or conveyor chain, which is designed to compensate for a circumferential offset of the conveyor belt or conveyor chain when there is a corrective change of the conveyor channel.

According to implementations of the device according to the invention, it is provided that the conveyor channel is realized curved in such a way that a conveying or transport direction of the packages is deflected as they move through the conveyor channel. For this purpose, the device includes an outer concave conveying side and an inner convex conveying side, wherein the conveyor channel is formed at least in certain areas between the outer concave conveying side and the inner convex conveying side. The outer concave conveying side and/or the inner convex conveying side includes the plurality of guide sections, which are radially adjustable with regard to the direction of movement of the packages through the conveyor channel.

### BRIEF DESCRIPTION OF THE DRAWINGS

An exemplary embodiment of the invention is described in more detail below with reference to the accompanying drawings.

It is shown in:

FIG. 1 schematically and in a first isometric view, an exemplary embodiment of the device for in-or out-feeding packages into a storage line or out of a storage line of a storage table according to the invention;

FIG. 2 schematically and in a second isometric view, the exemplary embodiment of the device according to the invention according to FIG. 1;

FIG. 3 schematically and in a third isometric view, the exemplary embodiment of the device according to the invention according to FIG. 1;

FIG. 4 schematically and in an isometric view, details of the exemplary embodiment of the device according to the invention according to FIG. 1;

FIG. 5A schematically and in an isometric view, the outer concave conveying side of an alternative device for in-or out-feeding packages into a storage line or out of a storage line of a storage table;

FIG. 5B schematically and in an isometric view, the outer concave conveying side of the device according to FIG. 5A without a cover plate;

FIG. 5C schematically and in a plan view, the outer concave conveying side of the device according to FIG. 5B; and

FIG. 5D schematically and in a sectional view, the outer concave conveying side of the device according to FIG. 5C.

### DETAILED DESCRIPTION

The subject matter of the invention-as shown in the drawings using an exemplary embodiment-is a device 1 for in-or out-feeding packages into a storage line not shown in the drawings or out of a storage line (not shown in the drawings) of a storage table. A curved conveyor tunnel or conveyor channel 2 is used for this purpose, the width of which is adaptable to the products to be conveyed, without the need for assembling or disassembling format-related parts for this purpose.

As is subsequently described in more detail with reference to the attached drawings, at least one outer side of the conveyor channel 2 and in particular the concavely shaped outer side of the conveyor channel 2 is radially adjustable.

The adjustment is operatable via a central adjustment mechanism, wherein this adjustment mechanism can also be motorically driven and controlled if required.

The individual guide sections 3 or guide segments of the outer conveying side grip the conveyor element, in this case a plastic chain belt 4 having attached lamellae, in a form-fitting manner. The guide sections 3 are arranged so that they are each linearly adjustable radiant to the center point of the curve radius. As a result, the outer conveyor chain 4 can be adjusted to various radii.

The circumferential offset due to the change in contour of the conveyor chain 4 is compensated for by a spring-loaded tensioning element 8.

The adjustment rotation of a handwheel 9 or a shaft of an electro-motorically drive can be transferred to the individual guide sections 3, for example, by means of a toothed belt 10.

For example, it is conceivable in this context for each guide section 3 to include a double toothed disc 11, whereby the adjustment rotation is transferred to the adjacent guide section 3 by means of a toothed belt 10. The linear movement of the respective guide section 3 is realized by a threaded spindle integrated therein.

However, the invention is not limited to an adjustment mechanism in which corresponding toothed belts 10 and/or double toothed discs 11 are employed. As an alternative to this, for example, an adjustment mechanism with bevel gears is also conceivable.

It is further conceivable that each individual guide section 3 is assigned its own drive, in particular a linear drive.

The exemplary embodiment of the device 1 for in- or out-feeding packages into a storage line or out of a storage line of a storage table according to the invention shown in the drawings is in particular a linearly operated satellite or deflector, which is movable transversely and preferably perpendicularly to the storage lines of the storage table (not shown).

The satellite or deflector includes a conveyor channel 2 via which packages are conveyable to or from the storage line. The satellite or deflector is designed to be adaptable, in particular as needed, in such a way that the width and/or height of the conveyor channel 2 is adjustable at least in certain areas or sections.

In detail, in the exemplary embodiment shown in the drawings, it is provided that the conveyor channel 2 is realized curved in such a way that a conveying or transport direction of the packages is deflected, preferably by about 90°, as they move through the conveyor channel 2. For this purpose, the device 1 includes an outer concave conveying side 6 and an inner convex conveying side 7. The channel is formed at least in certain areas between the outer concave conveying side and the inner convex conveying side.

The outer concave conveying side 6 and/or the inner convex conveying side 7 includes the plurality of guide sections 3 or guide segments, which are radially adjustable with regard to the direction of movement of the packages through the conveyor channel 2.

The conveyor channel 2 is assigned a conveyor apparatus having at least one preferably circulating conveyor belt or having at least one preferably circulating conveyor chain 4, wherein the conveyor belt or the conveyor chain 4 is aligned at least substantially vertically and extends over the plurality of guide sections 3 or guide segments in a guided manner along the at least one of the two side areas arranged opposite one another.

For this purpose, an in particular spring-loaded tensioning element 8 is assigned to the conveyor belt or conveyor chain 4, which is designed to compensate for a circumferential offset of the conveyor belt or conveyor chain 4 when there is a corrective change of the conveyor channel 2.

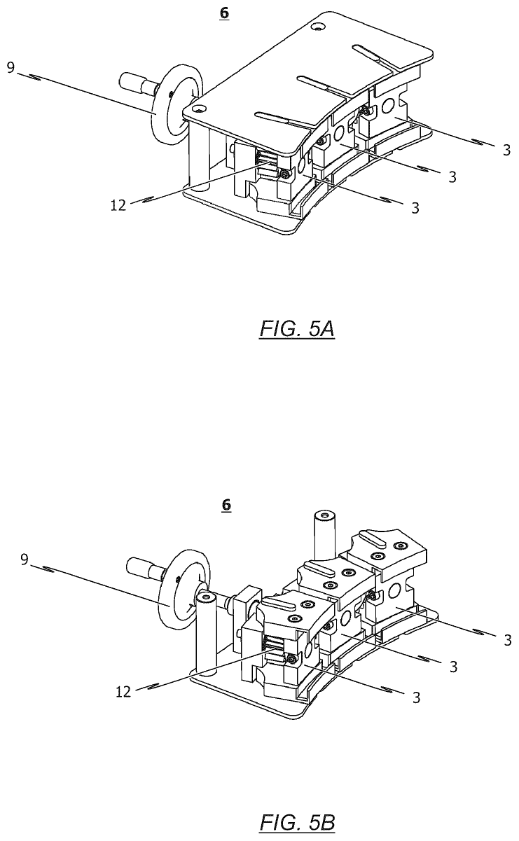

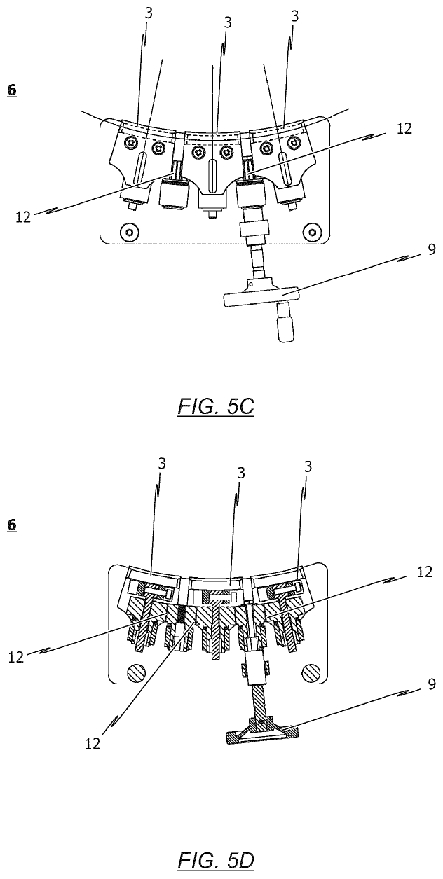

An alternative embodiment of the device according to the invention is shown in FIG. 5A through FIG. 5D. In detail, in FIG. 5A through FIG. 5D only the outer concave conveying side 6 of the device 1 is shown.

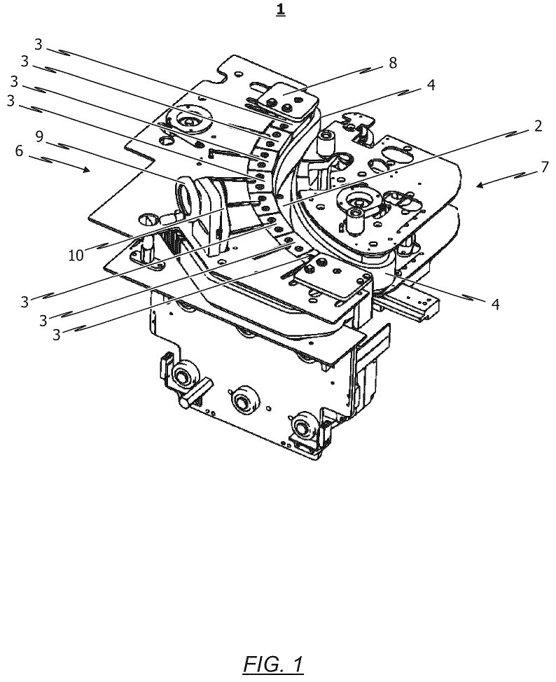

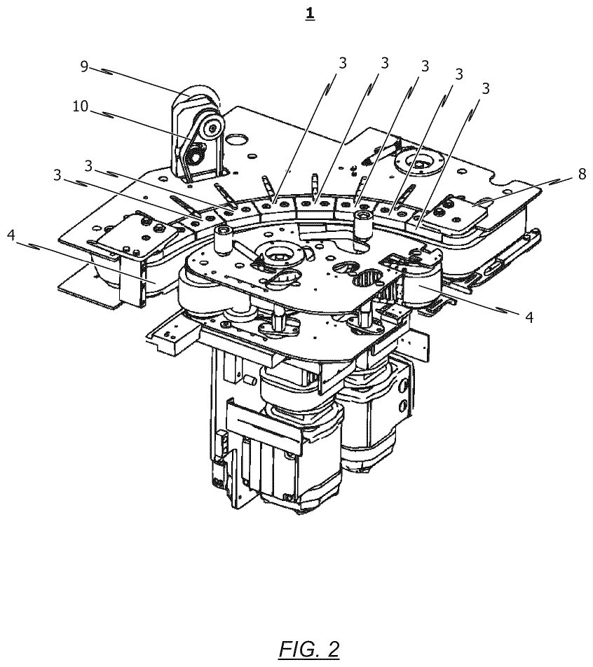

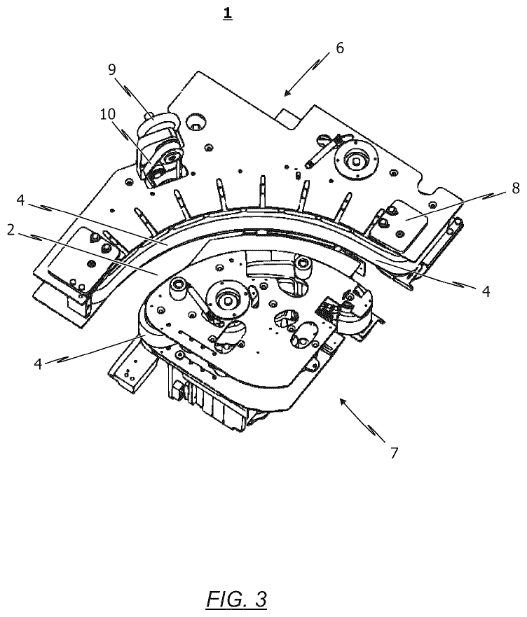

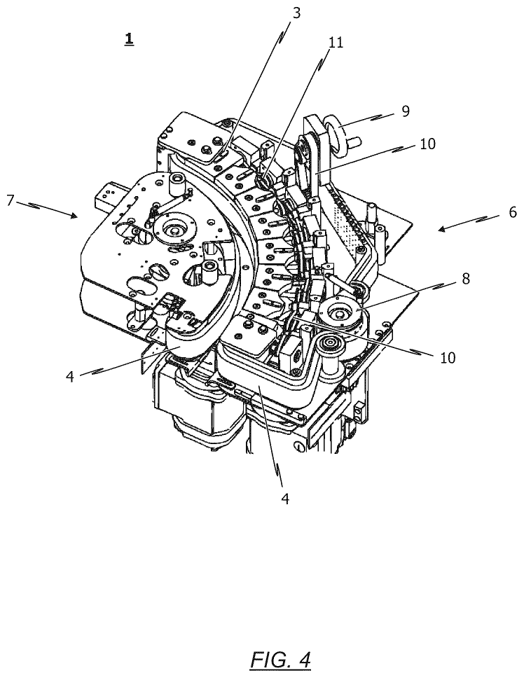

Like the device 1 described above, the device 1 shown in FIG. 5A through FIG. 5D comprises corresponding guide sections 3, which are adjustable with the help of a handwheel or drive 9. However, no toothed belt 10 is employed for adjusting the guide sections 3, as it is the case in the embodiment according to FIG. 1 to FIG. 4, instead corresponding bevel gears 12 are employed.

The rotational movement generated by the drive or handwheel 9 is transferred to the individual guide sections 3 by means of bevel gears 12.

The invention is not limited to the exemplary embodiment shown in the drawings, but results from a synopsis of all the features disclosed herein.

### LIST OF REFERENCE NUMERALS

1 Loading means/removal means or device for in- or out-feeding packages into a storage line or out of a storage line of a storage table
2 Conveyor channel
3 Guide section
4 Conveyor belt/conveyor chain
6 Outer concave conveying side
7 Inner convex conveying side
8 Tensioning element
9 Handwheel/drive
10 Toothed belt
11 Double toothed disc
12 Bevel gear

1. A storage table of a packaging plant, comprising:
at least one infeed;
at least one outfeed;
at least two storage lines that are loadable separately from one another and are arranged between the at least one infeed and the at least one outfeed;
wherein the at least one infeed includes a loading means having a conveyor channel, the loading means having the conveyor channel is designed to receive packages from a conveyor apparatus arranged upstream of the storage table and to convey the packages onwards and deflect the packages so the packages are received in at least one of the two storage lines, the loading means being adaptablesuch that one or more of a width or a height of the conveyor channel is adjustable at least in certain areas or sections.

2. The storage table according to claim 1, wherein the loading means of the at least one infeed is realized as a linearly operated satellite, which is movable transversely and perpendicularly to the at least two storage lines.

3. The storage table according to claim 1, wherein the loading means of the at least one infeed is a linearly operated deflector, which is movable transversely and perpendicularly to the at least two storage lines and which is designed to deflect the packages along a conveying or transport direction, starting from the conveyor apparatus arranged upstream of the storage table, so that the packages are moved to a specific, predetermined or determinable storage line of the at least two storage lines.

4. The storage table according to claim 1, wherein the conveyor channel of the at least one infeed includes two side areas arranged opposite one another and defining a conveying or transport direction, wherein at least one of the two side areas arranged opposite one another is segmentally designed and includes guide sections adjacent to one another, wherein at least one of the guide sections is one or more of movable or adjustable perpendicularly to the conveying or transport direction predefined by the conveyor channel as needed for adjusting the width of the conveyor channel at least in certain areas or sections.

5. The storage table according to claim 4, wherein at least one drive is assigned to the guide sections, the at least one drive being a manually operable or electro-motorically operable drive, the at least one drive and which is designed to one or more of move or adjust the at least one guide section assigned to the at least one drive perpendicularly to the conveying or transport direction predefined by the conveyor channel as needed.

6. The storage table according to claim 5, wherein the at least one drive includes a synchronization apparatus mechanically designed to transfer one or more of a movement or an adjustment of one of the guide sections caused by the at least one drive to another of the guide sections.

7. The storage table according to claim 1, wherein the at least one outfeed includes a removal means having a conveyor channel, the removal means having the conveyor channel is designed to receive the packages received in one of the at least two storage lines and to convey the packages onwards to deflect the packages so that the packages are received by a conveyor apparatus arranged downstream of the storage table, wherein the removal means is designed to be adaptable as needed in such a way that one or more of a width or a height of the conveyor channel is adjustable at least in certain areas or sections.

8. The storage table according to claim 7, wherein the removal means of the at least one outfeed is a linearly operated satellite, which is movable transversely and perpendicularly to the at least two storage lines.

9. The storage table according to claim 7, wherein the removal means of the at least one outfeed is a linearly operated deflector, which is movable transversely and perpendicularly to the at least two storage lines and which is designed to deflect the packages along their conveying or transport direction, starting from a conveyor apparatus assigned to the at least two storage lines, so that the packages are moved to the conveyor apparatus arranged downstream of the storage table.

10. The storage table according to claim 7, wherein the conveyor channel of the at least one outfeed includes two side areas arranged opposite one another and defining a conveying or transport direction, wherein at least one of the two side areas arranged opposite one another is segmentally designed and includes guide sections adjacent to one another, wherein at least one of the guide sections is one or more of movable or adjustable perpendicularly to the conveying or transport direction predefined by the conveyor channel as needed for adjusting the width of the conveyor channel at least in certain areas or sections.

11. The storage table according to claim 4, wherein a conveyor apparatus having at least one circulating conveyor belt or having at least one preferably circulating conveyor chain is assigned to the conveyor channel, wherein the conveyor belt or conveyor chain is aligned at least substantially vertically and extends over the guide sections adjacent to one another in a guided manner along at least one of the two side areas arranged opposite one another.

12. A device for in- or out-feeding packages into a storage line or out of the storage line of the storage table, according to claim 1, wherein the device includes a linearly operated satellite or deflector, that is transversely and perpendicularly movable to the storage line of the storage table, wherein the satellite or deflector includes a conveyor channel via which the packages are conveyable to or from the storage line, wherein the satellite or deflector is designed to be adaptable as needed in such a way that one or more of the width or the height of the conveyor channel is adjustable at least in the certain areas or sections.

13. The device according to claim 12, wherein the conveyor channel includes two side areas arranged opposite one another and defining a conveying or transport direction, wherein at least one of the two side areas arranged opposite one another is segmentally designed and includes a plurality of guide sections adjacent to one another, wherein at least one of the guide sections is one or more of movable or adjustable perpendicularly to the conveying or transport direction predefined by the conveyor channel as needed for adjusting the width of the conveyor channel at least in certain areas or sections.

14. The device according to claim 13, wherein a conveyor apparatus having at least one circulating conveyor belt or having at least one circulating conveyor chain is assigned to the conveyor channel, wherein the conveyor belt or conveyor chain is aligned at least substantially vertically and extends over the guide sections in a guided manner along at least one of the two side areas arranged opposite one another, wherein a spring-loaded tensioning element is assigned to the conveyor belt or conveyor chain, which is designed to compensate for a circumferential offset of the conveyor belt or conveyor chain when there is a corrective change of the conveyor channel.

15. The device according to claim 14, wherein the conveyor channel is curved in such a way that a conveying or transport direction of the packages is deflected as the packages move through the conveyor channel, wherein the device includes an outer concave conveying side and an inner convex conveying side, wherein the conveyor channel is formed at least in certain areas between the outer concave conveying side and the inner convex conveying side, wherein one or more of the outer concave conveying side or the inner convex conveying side includes the guide sections, which are radially adjustable with regard to the direction of movement of the packages through the conveyor channel.
